(19) United States
(12) Patent Application Publication
(10) Pub. No.: US 2025/0317097 A1
(43) Pub. Date: Oct. 9, 2025

(54) SOLAR ARRAY SUPPORT STRUCTURE

(71) Applicant: The Regents of the University of Michigan, Ann Arbor, MI (US)

(72) Inventors: Serife Tol, Ann Arbor, MI (US); Othman Oudghiri-Idrissi, Austin, TX (US); Avinkrishnan Vijayachandran, Ann Arbor, MI (US); Anthony M. Waas, Tempe, AZ (US); Ellen M. Arruda, Ann Arbor, MI (US); Xiaoming Mao, Ann Arbor, MI (US); Wei-Chun Lu, Ann Arbor, MI (US); Hrishikesh Danawe, Ann Arbor, MI (US)

(21) Appl. No.: 19/172,320

(22) Filed: Apr. 7, 2025

Related U.S. Application Data
(60) Provisional application No. 63/631,440, filed on Apr. 8, 2024.
(60) Provisional application No. 63/661,844, filed on Jun. 19, 2024.

(51) Int. Cl. H02S 30/20; F16B 9/02; F16M 11/22

(52) U.S. Cl. CPC H02S 30/20; F16B 9/02; F16M 11/22

(57) ABSTRACT

A support structure for a plurality of solar cells includes a truss and a plate engaged with the truss. The plate includes a plurality of polygonal panels. The plurality of polygonal panels are arranged such that the plate has a non-planar surface. Each polygonal panel of the plurality of polygonal panels is configured to support at least one solar cell of the plurality of solar cells.

This application claims the benefit of U.S. provisional application entitled “SOLAR ARRAY SUPPORT STRUCTURE,” filed Apr. 8, 2024, and assigned Ser. No. 63/631,440, and the benefit of U.S. provisional application entitled “SOLAR ARRAY SUPPORT STRUCTURE,” filed Jun. 19, 2024, and assigned Ser. No. 63/661,844, the entire disclosure of both of the provisional applications is hereby expressly incorporated by reference.

### STATEMENT REGARDING FEDERALLY SPONSORED RESEARCH OR DEVELOPMENT

This invention was made with government support under Contract No. HR0011-21-C-0241 awarded by the U.S. Department of Defense, Defense Advanced Research Projects Agency. The government has certain rights in the invention.

### BACKGROUND OF THE DISCLOSURE

### Field of the Disclosure

The disclosure relates generally to devices, methods, and systems for supporting a solar array in space.

### Brief Description of Related Technology

A space solar array is a space structure that supports photovoltaic cell technologies that convert solar energy into electric energy. The electric energy may be stored and used to power instruments and/or engines of the spacecraft. The electric energy may also be radiated, for example, beamed, to any location on Earth to power isolated and enclaved regions.

Space solar arrays shipped from Earth via rockets are constrained in that they must be deployable from a state in which they may be transported, for example, within a finite volume capacity of a transporting spacecraft. Additionally, the launch load of transport spacecraft including a space solar array leads to over-design of the transport spacecraft and thus increased costs.

### SUMMARY OF THE DISCLOSURE

In accordance with one aspect of the present disclosure, a support structure for a plurality of solar cells including a truss and a plate engaged with the truss. The plate includes a plurality of polygonal panels. The plurality of polygonal panels are arranged such that the plate has a non-planar surface. Each polygonal panel of the plurality of polygonal panels is configured to support at least one solar cell of the plurality of solar cells.

In accordance with another aspect of the present disclosure, a modular support structure for a plurality of solar cells includes a first support module and a second support module coupled to one another. The first support module and the second support module each include a truss and a plate engaged with the truss. The plates of the first support module and the second support module include a plurality of polygonal panels and a coupling hook configured to engage an adjacent plate. The plurality of polygonal panels are arranged such that the plate has a non-planar surface. Each polygonal panel of the plurality of polygonal panels of the plates of the first support module and the second support module is configured to support at least one solar cell of the plurality of solar cells.

In accordance with yet another aspect of the present disclosure, a method of assembling a support structure for a plurality of solar cells, the support structure including more than one support module, with each support module including a truss comprising a plurality of beams and a plurality of connectors, and a plate including a plurality of polygonal panels, the plurality of polygonal panels arranged such that the plate has a non-planar surface, each of the polygonal panels configured to support at least one solar cell is provided. The method of assembling the support structure including coupling the plurality of beams and the plurality of connectors, such that the truss is formed, and coupling a subset of the plurality of beams to a back side of the plate.

In connection with any of the aforementioned aspects, the devices, methods, and systems described herein may alternatively or additionally include any combination of one or more of the following features. The truss includes a plurality of beams, each beam of the plurality of beams includes an elastic material and a dissipative or dampening material periodically disposed within the elastic material. The dissipative or dampening material is viscoelastic. Each beam of the plurality of beams includes a hollow section. The plate includes a front side and a back side opposite the front side. The non-planar surface is disposed on the front side. The back side includes a plurality of sockets configured to engage the truss. The truss includes a plurality of composite beams. Each socket of the plurality of sockets is configured to receive a respective composite beam of the plurality of composite beams of the truss for coupling the plate to the truss. The truss further comprises a connector configured to couple two or more of the plurality of composite beams. The plate has a polygonal perimeter that defines a plurality of corners of the plate. Each socket of the plurality of sockets is disposed on the back side of the plate at a respective one of the corners. The plate includes a front side and a side wall extending backward from a front side of the plate along a periphery of the plate. The non-planar surface is disposed on the front side. The coupling hook comprises a spacer extending from the side wall and a flange extending from the spacer and offset from the side wall such that a slot is formed between flange and the side wall. The truss of each of the first support module and the second support module comprises a plurality of composite beams. Each of the first support module and the second support module includes a connector configured to couple two or more of the plurality of composite beams. The connector of each of the first support module and the second support module is configured to engage the connector of the other of the first support module and the second support module. The connector of each of the first support module and the second support module includes a through-hole configured to receive a fastener for coupling the connectors of each of the first support module and the second support module. The plate includes a front side and a back side. The non-planar surface is disposed on the front side. The back side includes a plurality of sockets configured to engage with the truss. The truss comprises a plurality of beams, each beam of the plurality of beams comprises an elastic material and a dissipative or dampening material periodically disposed within the elastic material. Each connector of the plurality of connectors includes at least two ports, each of the at least two ports configured to receive a beam of the plurality of beams. The method includes coupling the plurality of beams and the plurality of connectors includes inserting a beam of the plurality of beams into each port of the at least two ports of each of the plurality of connectors. The back side of the plate includes a plurality of sockets. The method includes coupling the subset of the plurality of beams to the back side of the plate includes inserting one of the plurality of beams into each socket of the plurality of sockets. The plate of each support module of the more than one support modules includes a coupling hook. The method includes interlocking the coupling hooks of the plates of each support module of the more than one support modules, to couple the more than one support modules. A connector of the plurality of connectors of each support module of the more than one support modules includes a through hole configured to receive a fastener. The method includes inserting a fastener through the through hole of the connector of the plurality of connectors of one of the support modules of the more than one support modules and the connector of the plurality of connectors of another one of the support modules of the more than one support modules, coupling the connectors of the respective support modules of the more than one support modules. The coupling the plurality of beams and the plurality of connectors and the coupling the subset of the plurality of beams to the back side of the plate occur in orbit. The method includes coupling a solar cell to a polygonal of the plurality of polygonal panels of a support module of the more than one support module.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 illustrates a perspective view of a support module in accordance with one examples of the present disclosure.

FIG. 2 is a front view of a plate in accordance with one example of the present disclosure.

FIG. 3 illustrates a back view of a plate in accordance with one example of the present disclosure.

FIG. 4A illustrates a front view of supplemental plate in accordance with one example of the present disclosure.

FIG. 4B illustrates a back view of the supplemental plate of FIG. 4A in accordance with one example of the present disclosure.

FIG. 5A illustrates a front view of a supplemental plate in accordance with another example of the present disclosure.

FIG. 5B illustrates a back view of the supplemental plate of FIG. 5A in accordance with another example of the present disclosure.

FIG. 6 illustrates first and second polygonal panel arrangements in accordance with examples of the present disclosure.

FIG. 7 illustrates a perspective view of a truss in accordance with one example of the present disclosure.

FIG. 8 illustrates a truss in a disassembled state in accordance with one example of the present disclosure.

FIGS. 9A-9C illustrates alternative beam configurations in accordance with several examples of the present disclosure.

FIG. 10 illustrates several hollow beams in accordance with examples of the present disclosure.

FIG. 11 illustrates two support structures in accordance with examples of the present disclosure.

FIG. 12 illustrates a back view of a support structure in accordance with one example of the present disclosure.

FIG. 13 is a flow chart of a method for assembling a support structure in accordance with one example of the present disclosure.

While the disclosed solar array support structures, methods, and systems are susceptible of embodiments in various forms, there are illustrated in the drawings (and will hereafter be described) specific embodiments of the invention, with the understanding that the disclosure is intended to be illustrative and is not intended to limit the invention to the specific embodiments described and illustrated herein.

### DETAILED DESCRIPTION OF THE DISCLOSURE

Structures for supporting a plurality of solar cells or a solar array in a space environment (e.g., in orbit) are described. Methods for assembling structures for supporting a plurality of solar cells in a space environment are also described. The structures for supporting a plurality of solar cells in a space environment or in-space solar support structures described herein may be manufactured in space. For example, the support structures described herein may be fabricated and assembled entirely in space. One or more aspects of the disclosed structures allow the structures to be fabricated/assembled in space, e.g., post-launch. For instance, one such aspect is that the constituent components of the structures may be manufactured entirely using additive manufacturing (3D printing). In some examples, inclusion of one or more metamaterials in at least one constituent component may allow the support structures to be manufactured in their entirety using additive manufacturing. Robots may assist in fabricating and assembling a support structure as described herein entirely in space. The support structures described herein may be fabricated and assembled entirely in space using materials brought from Earth and/or processed from the space environment, for example, the lunar regolith. The in-space solar support structures described herein may be manufactured in their entirety using additive manufacturing.

In-space solar support structures manufactured in space have fewer design constraints than those manufactured on and shipped from Earth. For example, in-space support structures manufactured in space do not need to be transported from earth in a deployed or deployable state, limited by the size and shape of a transporting spacecraft. Accordingly, development of in-space solar support structures capable of being fabricated and assembled in space is useful for extending the range of generated power in space, thus increasing the effectiveness of, and reducing the production costs of in-space solar support structures and space solar arrays including the same.

The design of in-space solar support structures can be optimized for a target power generation capacity. To this end, a set of metrics including precision, mass efficiency, stability, and resiliency may be used to assess the performance of an in-space solar support structure.

The precision of an in-space solar support structure URMS is defined as its root mean square (RMS) displacement average under loading acceleration due to attitude or altitude maneuvers or a thermal loading due to the full sun and eclipse cycles. The precision standard ranges from the micrometer order (10⁶ m) for optical systems to meter order (1 m) for large space solar arrays depending on the sensitivity of the system's operation to such deformation.

The mass efficiency metric is defined via the ratio of the mass of the in-space solar support structure to the mass of the solar panels σₘ, known as the structural mass fraction. The mass efficiency metric quantifies the relative amount of structural mass needed for the accurate operation of solar panels. The solar array design may be optimized by simultaneously minimizing the structural mass fraction and total mass of the space solar array while maintaining its precision below 1 m.

The stability of the solar array may be determined by its ability to attenuate external perturbations or loadings in time due to onboard engines or impacting space debris, which is directly related to its structural damping responsible for dissipating the induced (kinetic) energy. The structural damping is quantified via the damping ratios ξₙ, n≥0, associated with the in-space solar support structures' natural frequencies fₙ, which take nondimensional values between 0 (absence of dissipation—sustained displacement) and 1 (critically damped—very stable). The damping ratios associated with the natural frequencies, and corresponding eigenmodes of the structure may be representative of the structural damping, as the linear response of the structure to external loading can be expressed as a linear juxtaposition of the attenuating oscillation of all the eigenmodes.

The resiliency of the space solar array may be determined by its ability to maintain precision and withstand damage caused by external factors such as high-loading accelerations or destructive debris impact. It is quantified via the loss of precision after damage, which is capped at 10%.

The in-space solar support structures described herein may include (e.g., be composed of) one or more metamaterials. Metamaterials are structures or materials configured to exhibit specific properties that cannot be found in conventional (e.g., naturally occurring) materials, such as high stiffness and low mass properties and simultaneous high stiffness and high damping properties. In some examples, with the above definitions, in-space solar support structures as described herein may achieve improved mass-efficient, high-precision, stable, and resilient properties with inclusion of one or more metamaterial elements or components. For example, inclusion of a plate or plates that support solar cells having creased patterns and/or viscoelastic metamaterial beams constituting an underlying truss support for the plate or plates having creased patterns as provided herein may improve the mass-efficient, high-precision, stable, and resilient properties of an in-space solar support structure.

The support structures described herein may include one or more support modules. Each of the support modules may include a plate and a truss coupled to one another. The plate may include a plurality of polygonal panels arranged such that the plate has a non-planar or creased surface. The non-planar or creased nature of the plate may increase the stiffness of the plate, and thus the precision of a support structure or solar array including the same, while minimally increasing the mass of the plate. Each of the polygonal panels may be configured to support at least one solar cell.

The truss may include a plurality of beams. Each of the beams may include an elastic material and a dissipative or dampening material periodically disposed within the elastic material. The dissipative or dampening material may be viscoelastic. Each of the plurality of beams may include a hollow section.

The plate may further include a front side and a back side. The non-planar or creased surface may be disposed on the front side of the plate. The back side of the plate may include a plurality of sockets configured to engage the truss. For example, the truss may include a plurality of composite beams and each socket may be configured to receive a respective one of the plurality of composite beams for coupling the plate and the truss. The truss may further include a connector configured to couple two or more of the plurality of composite beams of the truss.

The in-space solar support structures described herein may be scalable or modular, so as to be extendable or reducible based on required power generation. An in-space solar support structure according to the present disclosure may include one or more support modules. According to the present disclosure an in-space solar support structure may include more than one support module coupled to one another. The quantity of support modules included in the support structure may be determined based on a required (or desired) power generation capacity of a solar array including the modular support structure. The size of a solar support structure may increase, and thus the quantity of support modules included in the support structure may increase as the power generating capacity of a solar array including the solar support structure increases.

The plates and/or trusses of adjacent support modules may engage or be coupled to one another. For example, the plate included in each support module may include a coupling hook configured to engage or be coupled to the coupling hook of the plate of an adjacent support module. For example, the plate of each support module may include a side wall extending backward from a periphery of the plate and the coupling hook of each plate may include a spacer extending from the side wall and a flange extending from the spacer and offset from the side wall such that a slot is formed between the flange and the side wall. The flange of the plate of each of the support modules may be configured to be inserted into the slot formed between the flange and the side wall of a plate (e.g., an adjacent plate) of an adjacent support module.

The truss of each of the support modules may include a plurality of connectors configured to couple two or more beams of the respective truss. The plurality of connectors of each of the support modules may include a through-hole configured to receive a fastener. A connector of the plurality of connectors of each of two adjacent support modules may be configured to receive a fastener for coupling the connectors of the adjacent support modules.

The support structures, methods, and systems described herein may be used independently or in combination with other known or later developed devices, methods, and systems for supporting solar cells and/or converting solar energy into electric energy.

Although described below in connection with solar arrays, the disclosed support structures and methods described herein are also useful in various other applications. For example, the disclosed in-space support structures may be used in connection with and/or to support or construct other in-space structures, for example, satellites, space stations, or the like.

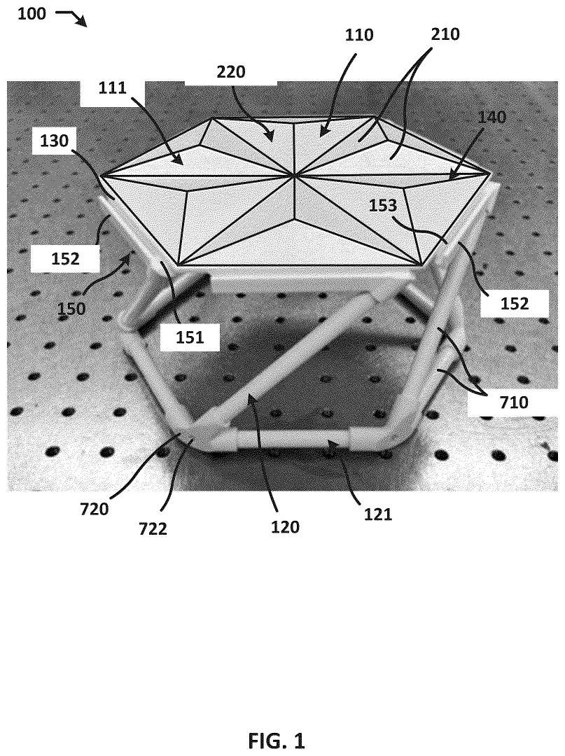

FIG. 1 illustrates a solar support module or support module 100 for an in-space solar support structure in accordance with one example of the present disclosure. As shown in FIG. 1, the support module 100 includes a plate 110 and a truss 120 engaged with one another. For example, as shown, the plate 110 and the truss 120 may be coupled to one another. The support module 100 may be configured to support solar cells coupled to the front or supporting surface of the plate 110. An orbital or in-space solar support structure according to the present disclosure may include one or more support modules 100. The quantity of support modules 100 included in a solar support structure according to the present disclosure may be determined based on a required power generation capacity of a solar array including the same. Two or more support modules 100 may be coupled to one another to create a support structure having a sufficiently large supporting surface to achieve the required power generation capacity. As described hereinafter in greater detail, the plates 110 and/or trusses 120 of adjacent support modules 100 may be coupled to one another, coupling the adjacent support modules.

According to some examples, a front or supporting surface 111 of the plate 110 and back layer 121 of the truss 120 may have corresponding shapes. For example, as shown in FIG. 1, the support surface 111 of the plate 110 and the back layer 121 of the truss 120 may each have a hexagonal shape. A support module 100 may be described herein as having a shape corresponding to the shape of a supporting surface 111 and back layer 121 of a truss constituting the support module 100. In some examples, as shown in FIG. 1, a supporting surface 111 of the plate and a back layer 121 of the truss may each have a hexagonal shape, and thus, the support module 100 may have a hexagonal shape. However, the present disclosure is not limited thereto, and the supporting surface 111 of the plate 110, back layer 121 of the truss 120, and thus, the support module 100 may have any shape. For example, supporting surface 111, back layer 121, and support module 100 may have another polygonal shape, such as, a triangular, rectangular, square, trapezoidal, pentagonal, heptagonal, or octagonal shape. In other examples, the supporting surface 111, back layer 121, and support module 100 may have a round, for example, a circular or ovular shape.

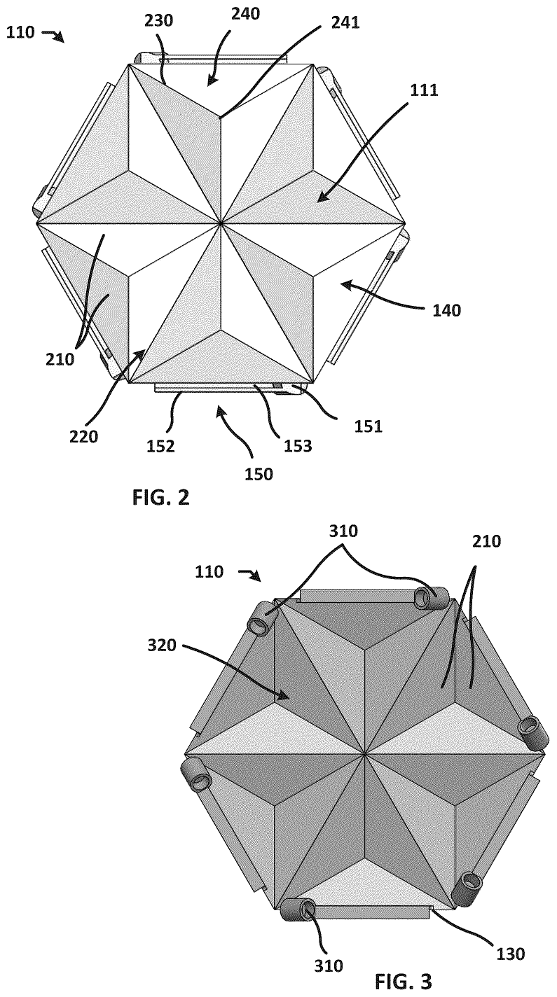

Referring to FIG. 2, a front view of a plate 110 is illustrated in accordance with one example of the present disclosure. The plate 110 may have a hexagonal front or supporting surface 111; however, as noted above, the present disclosure is not limited thereto. The front or supporting surface 111 may be configured to support a plurality of solar cells. In some examples, the supporting surface 111 may include a plurality of polygonal panels 210. Each of the polygonal panels 210 may be configured to support one or more solar cells. For example, one or more solar cells may be coupled to each of the polygonal panels 210. For example, the one or more solar cells may be coupled to one of the polygonal panels 210 using a glue or adhesive, one or more fasteners (e.g., screws, bolts, rivets, nails, or the like), thermal welding, or the like, or any combination thereof.

The quantity of polygonal panels 210 included in the plate 110 may vary. As shown, the polygonal panels 210 may have a triangular shape. However, the present disclosure is not limited thereto, and the polygonal panels 210 may have any polygonal shape, for example, the polygonal panels 210 may have a triangular, rectangular, square, trapezoidal, pentagonal, heptagonal, or octagonal shape. The plurality of polygonal panels 210 may be arranged such that the supporting surface 111 is non-planar and includes one or more creases 220. The plurality of or polygonal panels 210 may be arranged such that adjacent polygonal panels 210 intersect at a ridge 230 or crease 220. According to one or some embodiments, as described hereinafter in greater detail, the polygonal panels 210 may be provided in one or more units or groups 240. In some examples, as shown in FIG. 2, the polygonal panels 210 including in each group 240 may meet at an apex 241. The apex 241 may be a front most or furthest forward point of the plate 110.

According to the present disclosure, the arrangement of the polygonal panels 210, so as to form a non-planar or creased supporting surface 111 of the plate 110, may increase the stiffness of plate 110 while minimally increasing the mass of the plate 110. Accordingly, the precision of a solar array including a support structure with support modules having plates 110 including a non-planar or creased support surface 111 may be increased substantially, while minimally impacting the mass efficiency of the solar array.

According to some examples, supporting solar cells with a non-planar surface may be undesirable, as a relative power generation capacity of solar cells disposed on a non-planar surface may be less than that of the same solar cells disposed on a planar surface (e.g., disposed at a desirable angle with respect to the sun). However, according to the present disclosure, an increase in area of the plate 110, due to the inclusion of non-planar surfaces (e.g., surfaces of the plurality of polygonal panels 210) may allow for inclusion of additional solar cells, which may have a power generating capacity equal to or greater than the loss of power generation capacity due to the solar cells being supported by a non-planar surface.

Referring to FIG. 3, a back view of a plate 110 is illustrated in accordance with one example of the present disclosure. According to some examples, as shown in FIG. 3, the plate 110 may include one or more (e.g., a plurality of) sockets 310 disposed on the back side 320 of the plate 110. In some examples, as shown in FIG. 3, a socket 310 may be disposed in each corner of a plurality of corners formed by a polygonal perimeter of the plate 110. Each of the sockets 310 may be configured to engage the truss of the support module, for example, truss 120 illustrated in FIG. 1. For example, each socket 310 may be configured to receive a beam for coupling the plate 110 and the truss to one another. For example, each socket 310 may include an opening configured to receive a portion of the beam. In some examples, as shown in FIG. 3, one or more (e.g., each of) the sockets 310 may be disposed at an oblique angle, so as to receive a beam disposed at an oblique angle with respect to the plate 110.

Referring to FIGS. 1-3, in some examples, the plate 110 may further include a side wall 130 extending backward from the front side 140 of plate 110 along a periphery or perimeter of the plate 110. In some examples, a side wall 130 may extend backward from the front side 140 of the plate 110 along each side of plate 110. In other examples, a side wall 130 may extend backward from a front side 140 of the plate 110 along less than all of the sides of the plate 110.

Still referring to FIGS. 1-3, the plate may further include a hook or coupling hook 150. The coupling hook 150 may be configured to engage an adjacent plate (e.g., of an adjacent support module). As shown in FIGS. 1-3, the coupling hook 150 may include a spacer 151 and a flange 152. The spacer 151 may extend outward from a side wall 130 of the plate 110 and the flange 152 may extend from the spacer 151. According to some examples, the spacer 151 may extend from the side wall 130 such that the flange 152 may be offset from the side wall 130 and thus a slot 153 may be formed between the side wall 130 and the flange 152. According to some examples, the side wall 130 and the flange 152 may be disposed parallel to one another, such that the slot 153 disposed between the side wall 130 and the flange 152 has a consistent width.

According to some examples, the coupling hook 150 may be configured to engage a coupling hook 150 of an adjacent plate 110. For example, coupling hooks 150 included in the plates 110 of adjacent support modules 100 may be configured to interlock with one another, so as to couple the plates 110 of adjacent support modules 100, and thus, couple the adjacent support modules 100. For example, the flange 152 of each of the coupling hooks 150 of the adjacent plates 110 may be inserted into the slot 153 disposed between the flange 152 and the side wall 130 of the other of the coupling hooks 150. In some examples, the plate 110 may include a single coupling hook 150. In other examples, the plate 110 may include more than one coupling hook 150. For example, the plate 110 may include a coupling hook 150 disposed on each side of a polygonal perimeter of the plate 110.

According to some examples, the plate 110 may include one or more metamaterials. For example, the plate 110 may be composed of an elastic metamaterial, for example, a fluoropolymer configured to provide simultaneous high stiffness and low mass properties. For example, the plate may be composed of, or otherwise include Antero or another polyetherketoneketone (PEKK) based fused deposition modeling (FDM) thermoplastic. According to other examples, the plate 110 may be composed of, or otherwise include, a high modulus carbon fiber and cyanate ester composite material, such as, M55J carbon fiber. According to yet other examples, the plate 110 may be comprised of, or otherwise include, a polyetherimide, such as, Ultem.

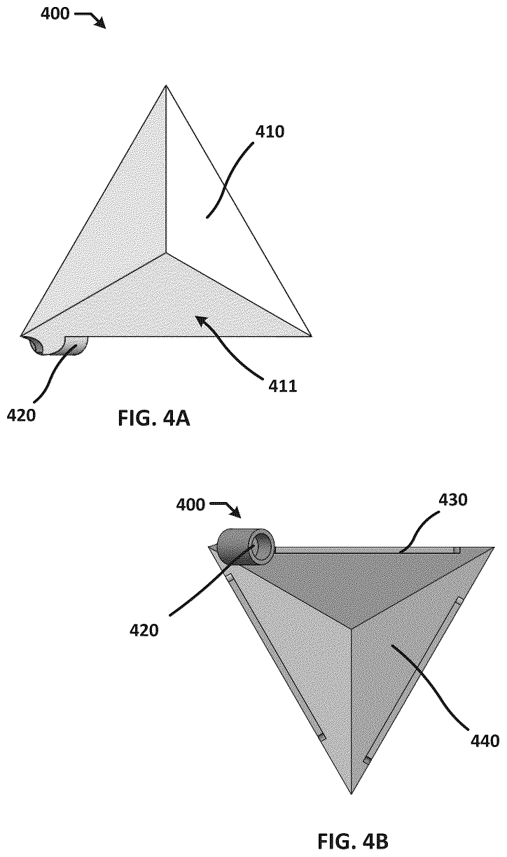

Referring to FIG. 4A, a front view of supplemental plate 400 is illustrated in accordance with one example of the present disclosure. According to the present disclosure, the supplemental plate may be coupled to the plate of two or more adjacent support modules (e.g., support modules 100 illustrated in FIG. 1, so as to fill a gap or opening between the plates of the adjacent support modules. In one example, a supplemental plate 400 having a triangular shape, as shown in FIG. 4A, may be inserted between two adjacent support modules having a hexagonal shape (e.g., support modules 100 illustrated in FIG. 1, such that the adjacent support modules having hexagonal plates and the triangular supplemental plate may be arranged to have a common linear edge. In another example, a supplemental plate 400 having a triangular shape may be disposed between three support modules (e.g., support modules 100 illustrated in FIG. 1) including plates having a hexagonal shape, so as to fill a gap between the hexagonal plates of the support modules, creating a continuous front surface.

According to the present disclosure, the supplemental plate 400 may have a different shape than a plate, for example, plate 110 illustrated in FIG. 1, included in a solar support module, for example, support module 100 illustrated in FIG. 1. For example, the supplemental plate 400 may have a different polygonal shape than a plate included in the solar support module. In one example, as shown in FIG. 4A, the supplemental plate 400 may have a triangular shape. However, the present disclosure is not limited thereto, and the supplemental plate 400 may have any rectangular, square, trapezoidal, pentagonal, heptagonal, or octagonal shape. In other examples, the supplemental plate may have a round shape, for example, a circular or ovular shape. According to some examples, the supplemental plate may have a polygonal shape including less sides than the plate.

As shown in FIG. 4A, the supplemental plate 400 may include a plurality of polygonal panels 410 arranged so as to form a non-planar supporting surface 411. The polygonal panels 410 and supporting surface 411 may be the same as those described above with respect to the plate. For example, the plurality of polygonal panels 410 may be configured to support one or more solar cells and may substantially increase the stiffness of the supplemental plate 400, while minimally increasing the mass of the supplemental plate 400. According to some examples, as shown in FIG. 4A, the supplemental plate may not include any creases, but instead, the plurality of polygonal panels may be arranged such that one or more creases are created between the supplemental plate 400 and an adjacent plate, for example, the plate 110 of the support module 100 illustrated in FIG. 1.

Referring to FIG. 4B, a back view of a supplemental plate 400 is illustrated in accordance with one example of the present disclosure. According to some examples, as shown in FIG. 4B, the supplemental plate 400 may include a socket 420. The socket 420 may be the same as those discussed above with respect to the plate of a solar support module, for example, the socket 420 may be the same as or substantially similar to the socket 310 described above with respect to FIGS. 1-3. For example, the socket 420 may be configured to receive a beam of a truss for coupling the supplemental plate 400 and a truss coupled to the supplemental plate 400. According to some examples, a truss or supplemental truss coupled to the supplemental plate 400 may include a first beam disposed in the same plane as a side or edge of the supplemental plate 400 and disposed at an oblique angle with respect to the supplemental plate 400. Additionally, the supplemental truss may include a second beam disposed in the same plane as a side of the supplemental plate 400 and parallel to the supplemental plate 400. The second beam may be connected to the first beam via a connector and extend from the first beam. As shown in FIG. 4B, in some examples, the supplemental plate 400 may include a projecting edge 430 extending backward, away from the back side 440 of the supplemental plate 400. According to some examples, as shown in FIG. 4B, the projecting edge 430 may be disposed along a side of the supplemental plate 400. According to some examples of the present disclosure, the projecting edge 430 may be configured to be inserted into a slot formed between the side wall and the flange of a coupling hook of an adjacent plate of solar support module, for example, the support module 100 illustrated in FIG. 1, coupling the supplemental plate 400 and the plate of the solar support module to one another.

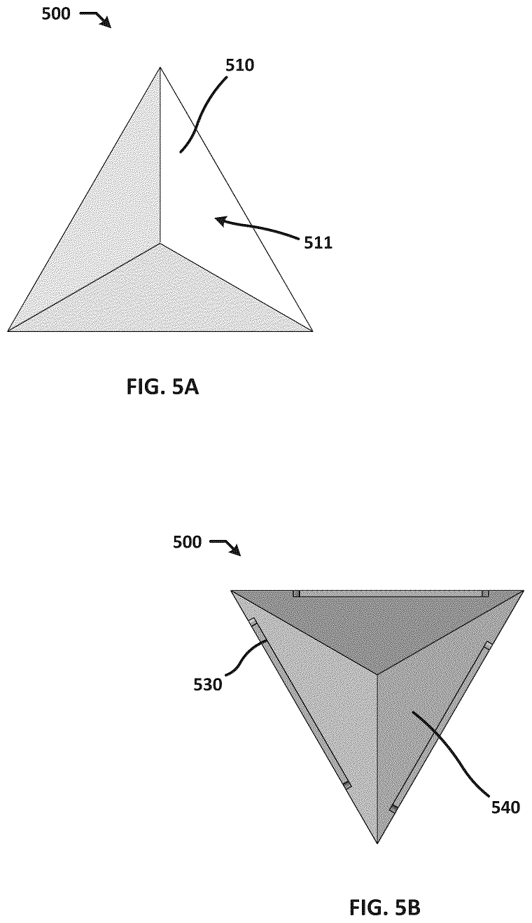

Referring generally to FIGS. 5A and 5B, a supplemental plate 500 is illustrated in accordance with another example of the present disclosure. As shown in FIG. 5A, the supplemental plate 500 may include a plurality of polygonal panels 510 arranged so as to form a non-planar supporting surface 511. Additionally, the supplemental plate 500 may include a projecting edge 530 extending backward, away from a back side 540 of the supplemental plate 500. The supplemental plate 500 as illustrated in FIGS. 5A and 5B may be the same as or substantially similar to the supplemental plate 400 as illustrated and described above with respect to FIGS. 4A and 4B; however, the supplemental plate 500 of FIGS. 5A and 5B does not include a socket, and instead may be coupled to the plates of adjacent support modules, for example, support modules 100 illustrated in FIG. 1, using only the projecting edge 530.

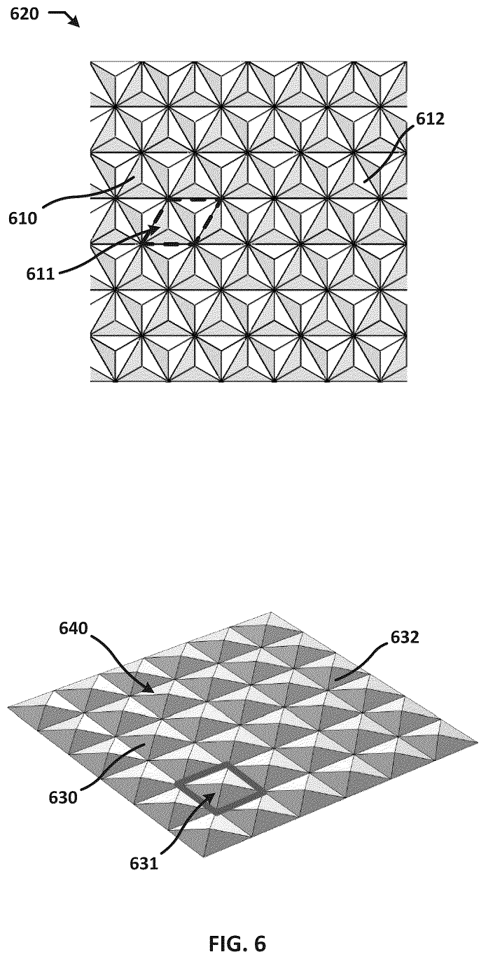

Referring to FIG. 6, two different patterns or arrangements of polygonal panels are illustrated in accordance with examples of the present disclosure. FIG. 6 illustrates a plurality of polygonal panels 610 in a first arrangement 620 in accordance with one example of the present disclosure. Additionally, FIG. 6 illustrates a plurality of polygonal panels 630 in a second arrangement 640 in accordance with one example of the present disclosure. In some examples, the polygonal panels included in and comprising the supporting surface of the plate, for example, the plate 110 of the support module 100 of FIG. 1, or the supplemental plates 400, 500 illustrated and described above with respect to FIGS. 4A-5B, may be arranged according to either the first arrangement 620 or the second arrangement 640 of FIG. 6.

According to some examples, as shown in the first arrangement 620 of FIG. 6, the plurality of polygonal panels 610 may be arranged in a hexagonal lattice. For example, the plurality of polygonal panels 610 included in each group or unit 611 of the hexagonal lattice may be arranged so as to form a pair of triangular pyramids. In some examples, as shown in the second arrangement 640 of FIG. 6, a different triangular shaped polygonal panel may constitute a face 612 of each of the pair of triangular pyramids. In other words, each of the three triangular faces 612 of the triangular pyramid may be formed or defined by a different one of the plurality of polygonal panels 610. According to some examples of the present disclosure, the hexagonal or first arrangement 620 of the polygonal panels 610 may be repeated across or over the entirety of a supporting surface of a plate. For example, the first arrangement 620 may be repeated or provided over a front surface of the plate 110 of the support module 100 illustrated in FIG. 1, the supplemental plate 400 illustrated and described above with respect to FIGS. 4A and 4B, and/or the supplemental plate 500 illustrated and described above with respect to FIGS. 5A and 5B. Thus, the first arrangement 620 of the polygonal panels 610 may be repeated across the entire front or supporting surface of a support module included in a support structure and/or across the entirety of a supporting surface of a support structure according to the present disclosure.

In other examples, as shown in the second arrangement 640 of FIG. 6, the plurality of polygonal panels 630 may be arranged in a rectangular lattice. For example, the plurality of polygonal panels 630 included in each group or unit 631 of the rectangular lattice may be arranged so as to form a rectangular pyramid. In some examples, as shown in FIG. 6, a different triangular shaped polygonal panel 630 may constitute each face 632 of the rectangular pyramid. In other words, each of the four triangular faces 632 of the rectangular pyramid may be formed or defined by a different one of the plurality of polygonal panels 630. According to some examples of the present disclosure, the rectangular or second arrangement 640 of the polygonal panels 630 may be repeated across the entirety of a supporting surface of a plate. For example, the second arrangement 640 may be repeated or provided over a front or supporting surface of the plate 110 of the support module 100 illustrated in FIG. 1, the supplemental plate 400 illustrated and described above with respect to FIGS. 4A and 4B, and/or the supplemental plate 500 illustrated and described above with respect to FIGS. 5A and 5B. Thus, the second arrangement 640 of the polygonal panels 630 may be repeated across the entire front or supporting surface of a support module included in the support structure and/or across the entirety of a supporting surface of the support structure.

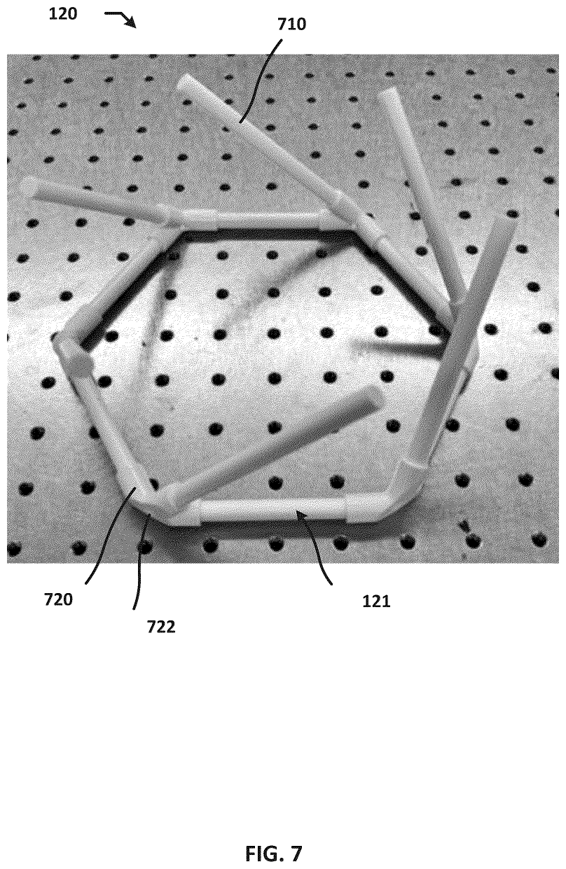

Referring to FIG. 7, a perspective view of a truss 120 is illustrated in accordance with one example of the present disclosure. As shown in FIG. 7, the truss 120 may include a plurality of beams 710 and a plurality of connectors 720. In some examples, as shown in FIG. 7, the back layer 121 of the truss 120 may have a hexagonal shape. However, as noted above, the present disclosure is not limited thereto, and the back layer 121 may have another shape. In some examples, as shown in FIG. 7, in addition to the back layer 121, the truss 120 may include a plurality of beams 710 extending away from the back layer 121 and configured to engage the plate, for example, the plate 110 of support module 100 illustrated in FIG. 1. In accordance with some examples, as illustrated in FIG. 7, the beams 710 extending away from the back layer 121 may be disposed at an oblique angle with respect to the planar, back layer 121. According to some examples, as shown in FIG. 7, each of the beams 710 extending from the back layer 121 may be coplanar with a beam 710 constituting the back layer 121.

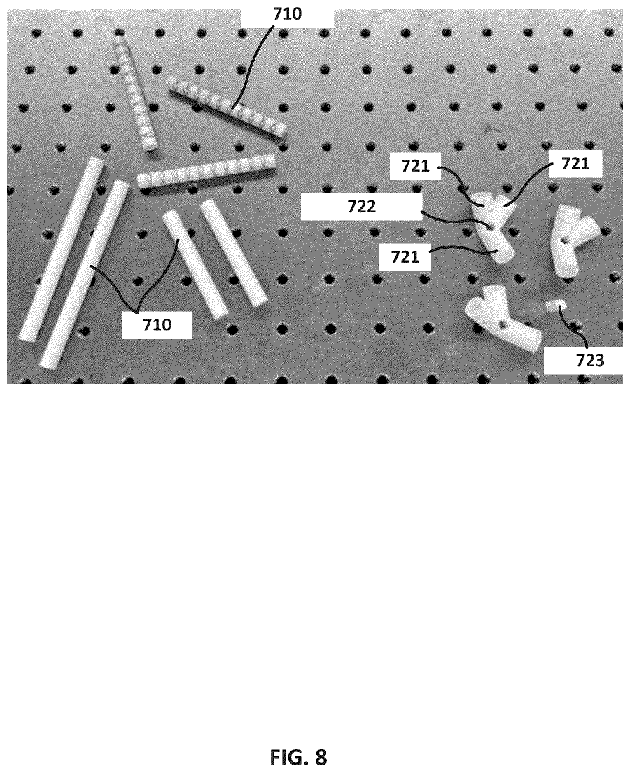

Referring to FIG. 8, a plurality of beams 710 and connectors 720 constituting a truss, for example, the truss 120 illustrated in FIGS. 1 and 7, are illustrated in accordance with one example of the present disclosure. Each of the connectors 720 may be configured to couple two or more of the plurality of beams 710 constituting the truss. A connector 720 according to the present disclosure may include two or more ports 721. Each port 721 may be configured to receive a beam 710, coupling the beam 710 to the connector 720. The beam 710 may be coupled to the port 721 using an interference fit (e.g., a press fit, a friction fit, a snap fit), an adhesive or glue, plastic welding, one or more fasteners (e.g., bolts, screws, rivets, nails, and the like), or the like, or any combination thereof. According to some examples, as shown in FIG. 8, one or more of (e.g., each of) the connectors 720 may include three ports 721 and be configured to couple three beams 710 to one another. Each port 721 may be configured to receive a beam 710, coupling the respective beam 710 to the connector 720, and thus to other beams 710 coupled to the other ports 721 of the connector 720.

As shown in FIGS. 8, each of the plurality of connectors 720 may further include a through-hole 722 extending therethrough. According to the present disclosure, the through-hole 722 of each of the plurality of connectors 720 may be configured to receive a fastener 723 for coupling a pair of adjacent connectors 720. According to some examples, a pair of adjacent connectors 720 included in adjacent support modules, for example, adjacent ones of the support module 100 illustrated in FIG. 1, and/or adjacent supplemental support modules including one of the supplemental plates 400 or 500 illustrated and described above with respect to FIGS. 4A-5B, may each be configured to receive a fastener 723 for coupling the adjacent connectors 720 to one another, and thus, the adjacent support modules to one another. According to some examples, as shown in FIG. 8, the fastener 723 may be a rod, pin, or peg having a cross shape. However, the present disclosure is not limited thereto and in examples, the fastener may be a rod, pin, or peg having another cross-sectional shape.

According to some examples, one or more (e.g., each of) the beams 710 included in the truss, for example, the truss 120 illustrated in FIGS. 1 and 7, may have a cylindrical or tubular shape. However, the present disclosure is not limited thereto and a cross section of one or more of the plurality of beams 710 may have any shape. For example, a cross section of one or more (e.g., each) of the plurality of beams 710 may have a polygonal shape, such as a triangular, rectangular, square, trapezoidal, pentagonal, of hexagonal shape. In other examples, one or more (e.g., each of) of the plurality of beams 710 may have another round, for example, an oval or elliptic shape. According to some examples, all of the beams 710 included in the truss may be the same length. According to other examples, the truss, for example, the truss 120 illustrated in FIGS. 1 and 7, may include two or more beams 710 having different lengths.

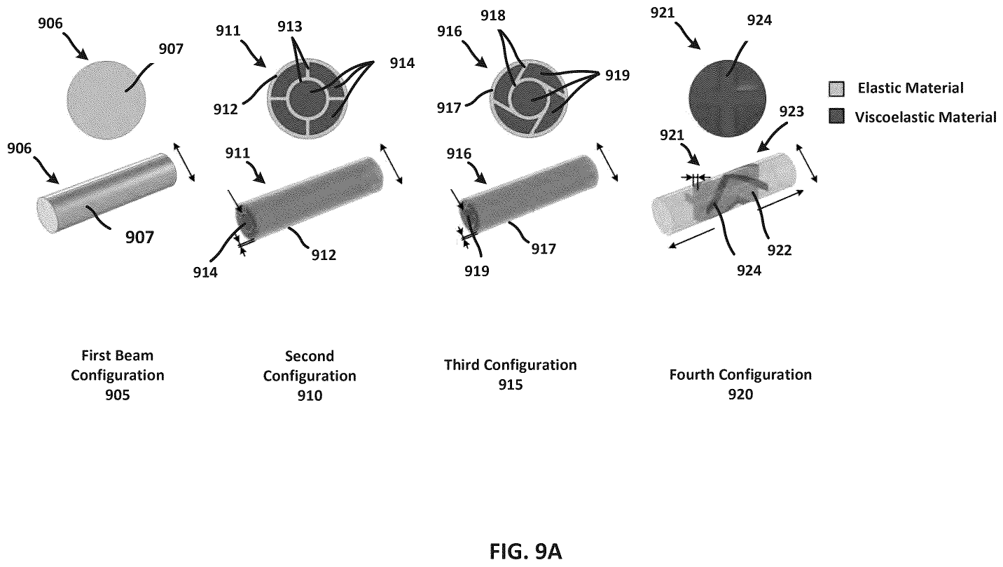

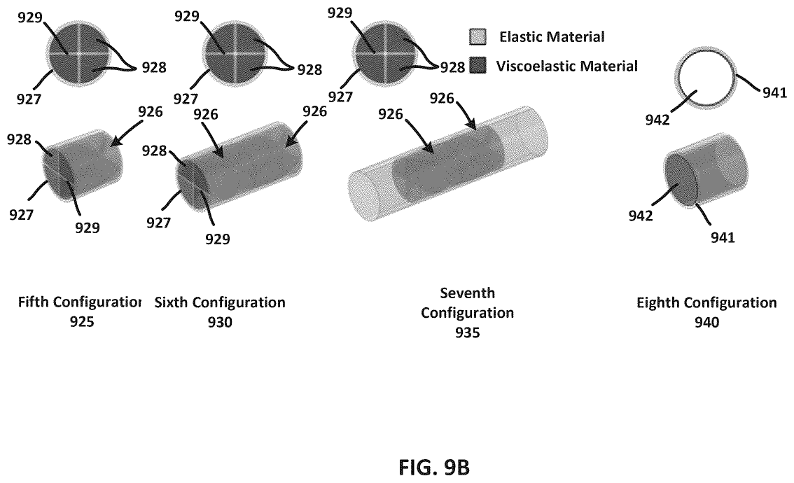

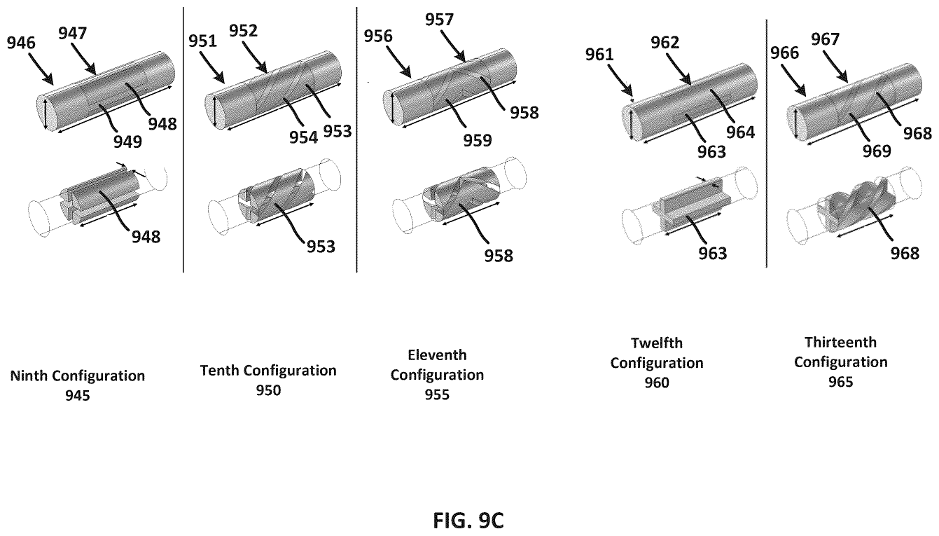

Referring to FIGS. 9A-9C, various tubular beam configurations are illustrated in accordance with examples of the present disclosure. According to some examples, one or more (e.g., each) of the plurality of beams, for example, the beams 710 illustrated and described above with respect to FIGS. 7 and 8, may be composed of one or more metamaterials. As noted above, metamaterials are a type of material engineered to have properties that are not found in conventional or naturally occurring materials. For example, in conventional or naturally occurring materials, there is a trade-off between stiffness and damping properties. A metamaterial, for example, a metamaterial beam according to the present disclosure may be configured to provide, for example, simultaneous high stiffness and high damping properties. For examples, one or more (e.g., each) of the beams may be composed of, or otherwise include one or more fluoropolymers. According to some examples, the presence of fluorine in the polymer may give the polymer high heat resistance or thermal stability properties. According to some examples, one or more (e.g., each) of the plurality of beams may be composed of, or otherwise include one or more composite materials. In a first configuration 905, as shown in FIG. 9A, the beam 906 may be a solid beam composed of a single material. For example, in the first configuration 905, the beam 906 may be composed of a singular tubular shaft or rod 907 composed of an elastic material. In some examples, the beam 906 in the first configuration 905 may be composed of an elastic metamaterial, for example, the beam may be composed of an elastic fluoropolymer, such as, Antero. According to some examples, the beam 906 in the first configuration 905 may be composed of, or otherwise include another elastic metamaterial such as a high modulus carbon fiber and cyanate ester composite material (e.g., M55J carbon fiber). According to some examples, the beam 906 in the first configuration 905 may be composed of or otherwise include a polyetherimide, such as, Ultem.

Referring to the second configuration 910 and third configuration 915 of FIG. 9A, one or more (e.g., each) of the beams 911, 916 included in the truss, for example, truss 120 illustrated in FIG. 1, may be a composite beam composed of two or more materials. For examples, as shown in the second and third configurations 910, 915, one or more of the beams 911, 916 may be composed of an elastic material and a dissipative, dampening, or viscoelastic material. According to some examples, the elastic material and the viscoelastic material may each be a metamaterial. For example, the elastic material and the viscoelastic material may each be a fluoropolymer. In some examples, the elastic material may be Antero. In some examples, the dampening or viscoelastic material may be Dalso or Viton. In some examples, the elastic material may be composed of, or otherwise include, a silicone ablative material, such as, DowSil. In some examples, the dampening or viscoelastic material may be another synthetic rubber and fluoropolymer elastomer. According to some examples, as illustrated in the second and third configurations 910, 915 of FIG. 9A, one or more of the beams 911, 916 included in the truss may include an elastic material and a viscoelastic disposed continuously along the length of the beam 911, 916. According to one example, a beam 911 in the second configuration 910, as shown in FIG. 9A, may have an exterior surface 912 and one or more interior walls 913 composed of an elastic material and include interior sections 914 composed of a viscoelastic material having an achiral cross sectional shape. In other words, mirror images of a cross section of beam 911 may be superimposable or overlap one another. In another example, a beam 916 in the third configuration 915, as shown in FIG. 9A, may have an external surface 917 and one or more interior walls 918 composed of an elastic material and include interior sections 919 composed of a viscoelastic material having a chiral cross-sectional shape. In other words, mirror images of cross section of the beam 916 may not be superimposable or overlap one another. In some examples, as illustrated in the fourth configuration 920 of FIG. 9A, the beam 921 may be composed of an elastic material and may include a dampening or viscoelastic material disposed periodically along the length of the beam 921. For example, in the fourth configuration 920, the beam 921 may include a segment 923 of viscoelastic material having a cross shape support 924 disposed at regular or irregular intervals along the length of the beam 921. In the fourth configuration 920, the segment 923 may further include a plurality of (e.g., four) _sections or quadrants 922 formed of an elastic material. In some examples, as shown in the fourth configuration 920, an orientation of the cross shape support 924 composed of viscoelastic material may rotate along a length of the segment 923 and the beam 921. For example, as shown in the fourth configuration 920, an orientation of the cross shape support 924 composed of viscoelastic material may rotate 90 degrees in a first direction, before rotating back 90 degrees in a second, opposite direction in each segment 923.

Referring to FIG. 9B, various tubular beam configurations are illustrated in accordance with additional examples of the present disclosure. According to some examples, a beam in the fifth configuration 925, sixth configuration 930, or seventh configuration 935, as shown in FIG. 9B, may include one or more segments 926 of viscoelastic material disposed along a length of the respective beams. In one or some embodiments, each of the one or more segments 926 may have an external or peripheral surface 927 comprised of an elastic material and include one or more interior quadrants or sections 928 composed of a viscoelastic material. As shown in the fifth configuration 925, sixth configuration 930, and seventh configuration 935, each of the beam configurations may include one or more segments 926 of viscoelastic material (e.g., disposed along the length of) the beam. The one or more segments 926 of viscoelastic material (e.g., viscoelastic segments) may include interior quadrants or sections 928 composed of viscoelastic material. Additionally, the one or more segments 926 may include a cross shape internal support 929 composed of an elastic material. According to some examples, as shown in the fifth configuration 925, sixth configuration 930, and seventh configuration 935, each segment 926 of the beam including an interior section composed of a viscoelastic material may include four sections 928 composed of a viscoelastic material disposed radially around a center of the beam. The cross shape internal support 929 composed on an elastic material may separate the sections 928 composed of a viscoelastic material. According to some examples, as illustrated in the fifth configuration 925, sixth configuration 930, and seventh configuration 935, an orientation of the (e.g., cross shape) internal support 929 and the plurality of sections 928 may rotate along a length of the segment 926 (and the respective beam in which the segment is included). As shown in the fifth configuration 925, sixth configuration 930, and seventh configuration 935 of Figure. 9B, a length of the segments 926 composed of a viscoelastic material may vary. In one or some examples, as shown in the fifth configuration 925, a segment 926 including a viscoelastic material may extend along an entire length of the beam.

Additionally, in one or some embodiments, as shown in the sixth configuration 930, a plurality of directly adjacent segments 926 may extend along an entire length of the beam. For example, the sixth configuration 930 may include a pair of adjacent segments 926 in which in the first segment 926 an orientation of the (e.g., cross shape) internal support 929 and the plurality of sections 928 may rotate 90 degrees in a first direction and in a second (e.g., directly) adjacent segment 926, an orientation of the (e.g., cross shape) internal support 929 and the plurality of sections 928 may rotate 90 degrees in a second direction, opposite the first direction. In one or some examples, as shown in the seventh configuration of FIG. 9B, one or more pairs of segments as described above in the sixth configuration 930 may be included at regular or irregular intervals along the length of the beam.

According to some examples, a beam in the eighth configuration 940 as shown in FIG. 9B may include an exterior or peripheral surface 941 composed of an elastic material and include one or more cylindrical interior sections 942 composed of a viscoelastic material. In some examples a cylindrical interior section 942 may extend along the entire length of the beam. In other examples, cylindrical interior sections 942 may be disposed at regular or irregular intervals along the length of the beam.

Referring to FIG. 9C, various tubular beam configurations in accordance with yet additional examples of the present disclosure are illustrated. FIG. 9C illustrates a plurality of periodic beam configurations, in which viscoelastic material segments are disposed periodically, for example, at regular or irregular intervals along a length of the respective beams. Specifically, FIG. 9C illustrates beams according to various examples of the present disclosure in which a viscoelastic material (e.g., a viscoelastic inclusion) having a different shape or pattern is disposed at regular or irregular intervals along the length of the beam.

According to one or some examples, one or more of the beams, for example, beams 710 included in the truss 120 illustrated and described above with respect to FIG. 7, may have the ninth configuration 945 illustrated in FIG. 9C. In the ninth configuration 945, the beam 946 may include one or more segments 947 including a viscoelastic material disposed at regular or irregular intervals along the length of the beam 946. In some examples, as shown in the ninth configuration 945, each segment 947 may include four quadrants or sections 948 composed of a viscoelastic material and a cross shaped internal support 949 composed of elastic material. In some examples, as shown, the each of the sections 948 composed of viscoelastic material may form a portion of an exterior surface of the beam 946. As shown, according to the ninth configuration 945, the beam 946 may have an achiral cross sectional shape.

According to one or some examples, one or more of the beams, for example, beams 710 included in the truss 120 illustrated and described above with respect to FIG. 7, may have the tenth configuration 950 illustrated in FIG. 9C. In the tenth configuration 950, the beam 951 may include one or more segments 952 including a viscoelastic material disposed at regular or irregular intervals along a length of the beam 951. As shown in the tenth configuration 950, each segment 952 may include four quadrants or sections 953 composed of a viscoelastic material and a cross shaped internal support 954 composed of elastic material. In some examples, as shown, the each of the sections 953 composed of viscoelastic material may form a portion of an exterior surface of the beam 951. In one or some examples, an orientation of the section 953 and the internal support 954 may rotate along the length of the segment 952 (and thus along the length of the beam 951). For example, as shown, the one or more sections 953 and the internal support 954 may rotate 180 degrees between opposite ends of the segment 952. However, the present disclosure is not limited thereto, and in other examples, the one or more sections 953 and the internal support 954 may rotate 45 degrees, 90 degrees, 135 degrees, or the like. As shown, according to the tenth configuration 950, the beam 951 may have an achiral cross sectional shape.

According to one or some examples, one or more of the beams, for example, beams 710 included in the truss 120 illustrated and described above with respect to FIG. 7, may have the eleventh configuration 955 illustrated in FIG. 9C. In the eleventh configuration 955, the beam 956 may include one or more segments 957 including a viscoelastic material disposed at regular or irregular intervals along the length of the beam 956. As shown, in the eleventh configuration 955, each segment 957 may include four quadrants or sections 958 composed of a viscoelastic material and a cross shaped internal support 959 composed of elastic material. In some examples, as shown, the each of the sections 958 composed of viscoelastic material may form a portion of an exterior surface of the beam 956. In one or some examples, an orientation of the one or more sections 958 and the internal support 959 may rotate along the length of the segment 957 (and thus along the length of the beam 956). For example, along a first half of the segment 957, the sections 958 of viscoelastic material and the internal support 959 may rotate 90 degrees in a first direction and along a second half of the segment, the sections 958 of the viscoelastic material and the internal support 959 may rotate 90 degrees in a second direction, opposite the first direction. As shown according to the eleventh configuration 955, the beam 956 may have an achiral cross sectional shape.

According to one or some examples, one or more of the beams, for example, beams 710 included in the truss 120 illustrated and described above with respect to FIG. 7, may have the twelfth configuration 960 illustrated in FIG. 9C. In the twelfth configuration 960, the beam 961 may include one or more segments 962 including a viscoelastic material disposed at regular or irregular intervals along the length of the beam 961. As shown, in the twelfth configuration 960, each segment 962 may include a cross shaped support 963 composed of a viscoelastic material. Each segment 962 may further include a plurality of (e.g., four) sections or quadrants 964 composed of an elastic material. As shown, in the twelfth configuration 960, the cross shaped support 963 may form a portion of an exterior surface of the beam 961. For example, each leg of the cross shaped support 963 may extend to an exterior surface of the beam 961, so as to form a portion of the exterior surface of the beam 961. As shown, according to the twelfth configuration 960, the beam 961 may have an achiral cross sectional shape.

According to one or some embodiments, one or more of the beams, for example, beams 710 included in the truss 120 illustrated and described above with respect to FIG. 7, may have the thirteenth configuration 965 illustrated in FIG. 9C. In the thirteenth configuration 965, the beam 966 may include one or more segments 967 including a viscoelastic material disposed at regular or irregular intervals along the length of the beam 966. As shown, in the thirteenth configuration 965, each segment 967 may include a cross shaped support 968 composed of a viscoelastic material. Each segment 967 may further include a plurality of (e.g., four) sections or quadrants 969 composed of elastic material disposed along a length of the segment 967. As shown, in the thirteenth configuration 965, the cross shaped support 968 may form a portion of an exterior surface of the beam 966. For example, each leg of the cross shaped support 968 may extend to an exterior surface of the beam 966, so as to form a portion of the exterior surface of the beam 966. As shown in the thirteenth configuration 965, an orientation of the cross shaped support 968 and the plurality of quadrants 969 may change along a length of the segment 967, and thus, along a length of the beam 961. For example, an orientation of the cross shaped support 968 and the plurality of quadrants 969 may rotate 180 degrees along the length of the segment 967 (e.g., between opposite ends of the segment 967). However, the present disclosure is not limited thereto and in other examples, an orientation of the cross shaped support 968 and the plurality of quadrants 969 may rotate 45 degrees, 90 degrees, 135 degrees, 225 degrees, 270 degrees, 315 degrees, or 360 degrees along the length of the segment 967. As shown, according to the twelfth configuration 960, the beam 961 may have an achiral cross sectional shape.

According to some examples, the inclusion of one or more beams, for example, beams 710 included in the truss 120 illustrated and described above with respect to FIG. 7, including an elastic metamaterial may increase the stiffness of the truss, and thus, the stiffness of a support module and a support structure including the same. According to some examples, all of the beams included in the truss of a support module, for example, support module 100 illustrated in FIG. 1, may include an elastic metamaterial. According to some examples, inclusion of one or more beams, for example, beams 710 included in the truss 120 illustrated and described above with respect to FIG. 7, including an elastic metamaterial and a viscoelastic metamaterial may provide the beam with simultaneous high stiffness and high dissipative or dampening properties. According to some example, all of the beams included in the truss of a support module, for example, support module 100 illustrated in FIG. 1, may include both an elastic metamaterial and a viscoelastic metamaterial. According to the present disclosure, inclusion of one or more beams composed of a viscoelastic metamaterial in a support module of a support structure according to the present disclosure may increase the stability of a solar array including a support structure as provided herein.

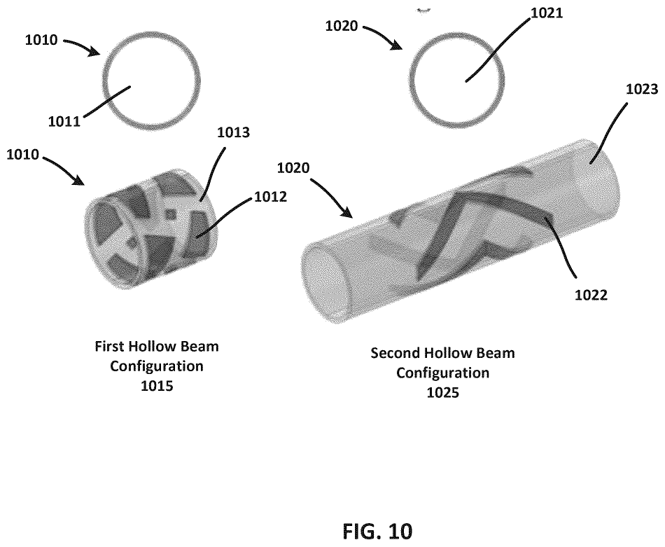

Referring to FIG. 10, hollow beams 1010 and 1020 are illustrated in accordance with examples of the present disclosure. In some examples, as shown in FIG. 10, a hollow beam 1010, 1020 in accordance with the present disclosure may include a hollow cylindrical shape cavity 1011, 1021, respectively. For example, a hollow beam 1010, 1020 in accordance with the present disclosure may include a hollow, cylindrical shape cavity 1011, 1021, respectively, extending along the length of the hollow beam 1010, 1020. According to some examples, the hollow, cylindrical shape cavity 1011, 1021 may extend a long a center of the hollow beam 1010, 1020, respectively. According to some examples, as shown in FIG. 10, a hollow beam 1010, 1020 according to the present disclosure may include one or more viscoelastic inclusions 1012, 1022 composed of a viscoelastic material included in an outer wall 1013, 1023 of the hollow beam 1010, 1020, respectively, composed of an elastic material. For example, in a first hollow beam configuration 1015 as shown in FIG. 10, the hollow beam 1010 may include viscoelastic inclusions 1012 in a rolled chiral pattern along the length of (e.g., a portion of) the hollow beam 1010. According to some examples, as shown in the second hollow beam 1025 configuration of FIG. 10, a hollow beam 1020 according to the present disclosure may include viscoelastic inclusions 1022 disposed in any pattern disposed at regular or irregular intervals along the length of the beam 1020.

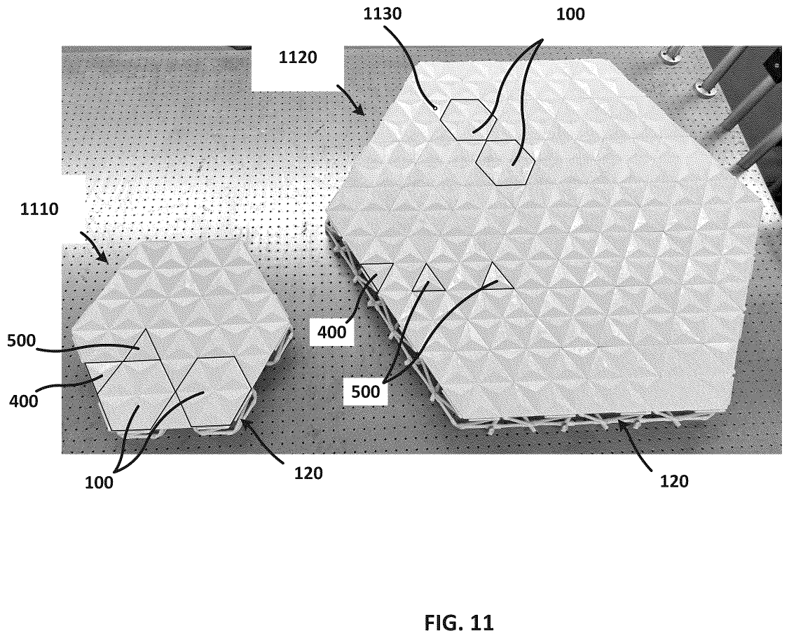

Referring to FIG. 11, two in-space solar support structures are illustrated in accordance with examples of the present disclosure. As noted above and shown in FIG. 11, the solar support modules as described herein may be modular, such that two or more support modules may be coupled to one another, forming support structures having various shapes and/or sizes. A support structure according to the present disclosure may include any number of support modules, for example, support modules 100 illustrated and described above with respect to FIG. 10 and/or supplemental plates or supplemental support modules, for example, supplemental plates 400, 500, described above with respect to FIGS. 4A and 4B, and 5A and 5B, respectively.

FIG. 11 illustrates a first support structure 1110 and a second support structure 1120 in accordance with two examples of the present disclosure. As shown in FIG. 11, each of the first support structure 1110 and the second support structure 1120 may be comprised of a plurality of support modules 100 and a plurality of supplemental plates 400 and 500.

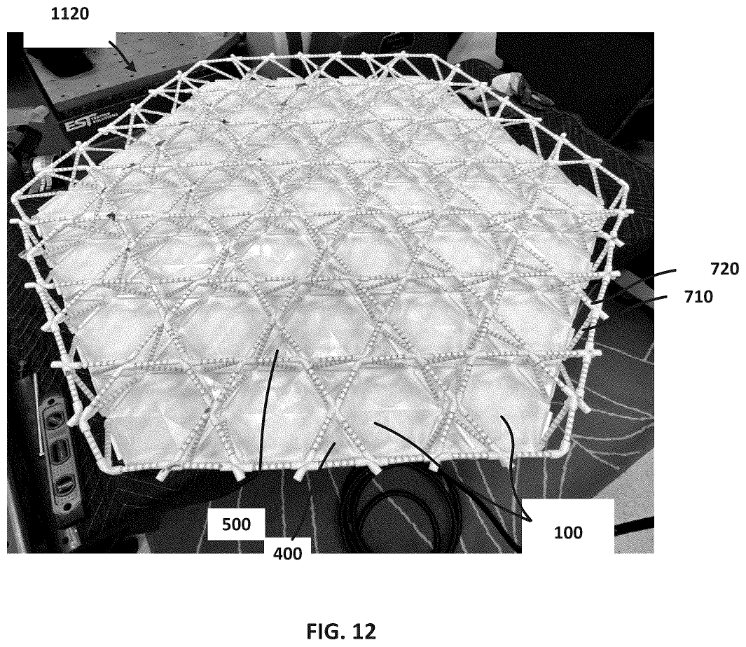

Referring to FIG. 12, a back side of the second support structure 1120 of FIG. 11 is illustrated in accordance with an example of the present disclosure. According to some examples, as illustrated in FIG. 12, adjacent support modules 100 and supplemental plates 400, 500 included in a support structure according to the present disclosure, for example, first support structure 1110 or second support structure 1120, may be coupled to one another via one or more coupling hooks, for example, coupling hook 150 illustrated and described above with respect to FIG. 2, included as a part of the plates (e.g., plate 110 illustrated in FIG. 2) of the support modules, for example, support modules 100 illustrated in FIG. 1 and/or via adjacent connectors, for example, connectors 720 as illustrated and described above with respect to FIGS. 7 and 8, included in the truss (e.g., truss 120 illustrated in FIG. 1) of adjacent support modules and/or adjacent supplemental support modules. For example, as described above, the flange, for example, flange 152 illustrated in FIG. 2 of a coupling hook, for example, the coupling hook 150 illustrated in FIG. 2, may be inserted into the slot, for example, the slot 153 illustrated in FIG. 2, of a coupling hook of an adjacent plate and/or the projecting edge of a supplemental plate may be inserted into the slot of a coupling hook, coupling adjacent support modules, for example, support modules 100 illustrated in FIG. 1 and/or supplemental plates, for example, supplemental plates 400, 500 illustrated and described above with respect to FIGS. 4A and 4B, and 5A and 5B, respectively, to one another. Additionally, or alternatively, a fastener, for example, fastener 723 illustrated and described above with respect to FIG. 7 may be inserted through the through-holes, for example, through-holes 722 of adjacent connectors 720 illustrated and described above with respect to FIG. 7, included in the trusses of adjacent support modules, coupling adjacent support modules.

Returning to FIG. 11, as noted above one or more solar cells 1130 may be coupled to each polygonal panel of a supporting surface of a plate or supplemental plate included in the support structure. Accordingly, a power generation capacity of a solar array including an in-space solar support structure 1110, 1120 according to the present disclosure may depend on an area of all of the supporting surfaces of the plates and/or supplemental plates included in the support structure 1110, 1120. The power generation capacity of a solar array including a support structure 1110, 1120 according to the present disclosure may be increased by increasing the total area of the supporting surfaces, of plates and/or supplemental plates included in the solar ray, for example, such that more solar cells may be coupled to the supporting structure, and thus, more power may be generated.

As described above, FIG. 11 illustrates a first support structure 1110 and a second support structure 1120 in accordance with two examples of the present disclosure. According to the present disclosure, the second support structure 1120 as shown in FIG. 11 is larger than the first support structure 1110. Accordingly, a solar array including or coupled to the second support structure 1120 may have a larger power generation capacity than a solar array including or coupled to the first support structure 111—(e.g., when the same solar cells and same density of solar cells are coupled to the supporting surface of the first support structure 1110 and the second support structure 1120, respectively).

As noted above, the solar support structures 1110, 1120 according to the present disclosure may be modular, so as to scale according to a required power generation capacity of a solar array including the same. Accordingly, in-space solar support structures according to the present disclosure may have areas in the ranging from less than 1 square meter to hundreds of square meters, for example 500 square meters, and beyond. According to the present disclosure, one or more properties of the solar support structures 1110, 1120 described herein may be maintained as the solar support structure 1110, 1120 are scaled. For example, high stiffness and low mass properties achieved by the plates described herein, for example, plate 110 described above with respect to FIGS. 2 and 3, may be maintained as a solar support structure according to the preset disclosure scales. For example, as solar support modules, for example, support module 100 illustrated and described above with respect to FIG. 1, are added to or removed from the solar support structure. Similarly, the benefits of simultaneous high stiffness and high damping properties of beams, for example, beams 710 illustrated and described above with respect to FIG. 7, may be maintained as a solar support structure according to the present disclosure is scaled.

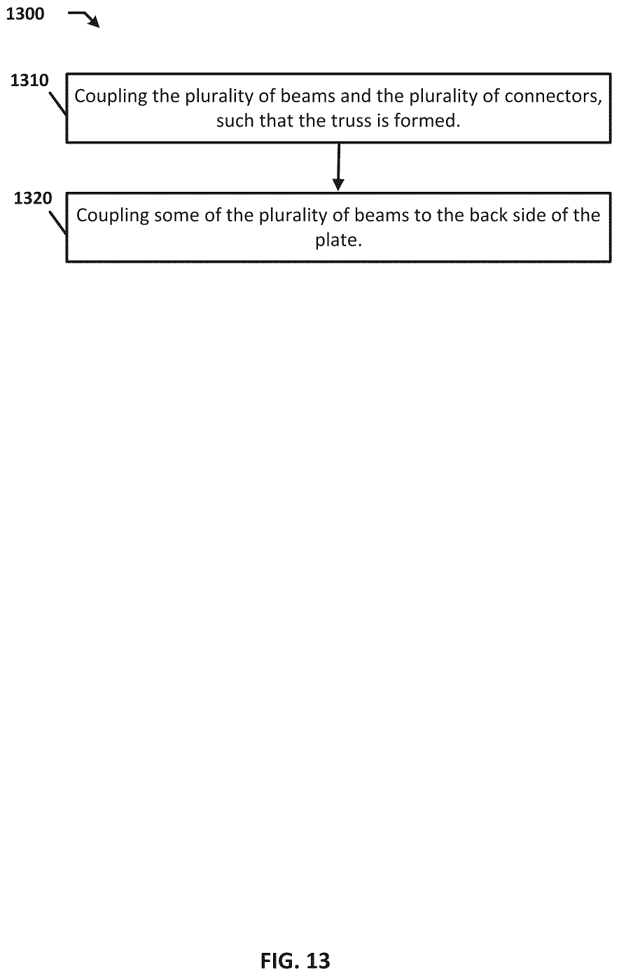

Referring to FIG. 13, a flow chart 1300 for assembling a solar support structure, for example, one of solar support structures 1110 or 1120 illustrated and described above with respect to FIG. 11, or another support structure in accordance with one example of the present disclosure is illustrated. Different, fewer, or additional acts may be provided. For instance, the flow chart 1300 of FIG. 13 may further include manufacturing one or more constituent components (e.g., a plate, beam, connector, or the like) of a support module in accordance with an example of the present disclosure using additive manufacturing, for example, 3D printing. The acts of the flow chart 1300 of FIG. 13 may be implemented in the order shown, but also may be implemented in or according to any number of different orders. For instance, a subset of the plurality of beams may be coupled to the back side of the plate before the plurality of beams and the plurality of connectors are coupled to one another, forming the truss.

In an act 1310, the plurality of beams and plurality of connectors may be coupled to one another, for example, the beams 710 and connectors 720 illustrated and described above with respect to FIG. 7, such that a truss of a support module, for example, support module 100 illustrated and described above with respect to FIG. 1, according to the present disclosure is formed. As described above with respect to FIG. 8, the plurality of connectors 720 may each include two or more ports 721 configured to receive one of the plurality of beams. In accordance with some examples of the present disclosure, a respective beam may be inserted into each port of the connector, so as to couple the respective beam to the connector, and thus to the other beams coupled to the connector. As described above, a respective one of the beams may be coupled to a corresponding port using an interference fit (e.g., a press fit, a friction fit, a snap fit), an adhesive or glue, plastic welding, one or more fasteners (e.g., bolts, screws, rivets, nails, and the like), or the like, or any combination thereof. According to some examples, each of the connectors may include at least two ports, each of the ports being configured to receive a beam of the plurality of beams. According to some examples. coupling the plurality of beams and the plurality of connectors includes inserting a beam of the plurality of beams into each port of the at least two ports of each of the plurality of connectors.

In an act 1320, a subset of the plurality of beams may be coupled to the back side of the plate, for example, the plate 110 illustrated and described above with respect to FIGS. 2 and 3. In some examples, a subset including the plurality of beams extending away from the planar back panel of the truss may be coupled to the back side of the plate. According to some examples, as described above with respect to FIG. 3, the back side of the plate may include one or more (e.g., a plurality of) sockets 310. In these examples, the coupling a subset of the plurality of beams to the back side of the plate may include inserting each one of the beams extending away from the back panel into a respective socket disposed on a back side of the plate.

According to some examples, the flow chart 1300 of FIG. 13 may further include interlocking the coupling hooks, for example, coupling hooks 150 described and illustrated above with respect to FIGS. 1 and 2, of the plates of each support module of the more than one support modules, to couple the more than one support modules. According to some examples of the present disclosure, a supplemental plate, for example, supplemental plate 400 or 500 illustrated and described above with respect to FIGS. 4A and 4B and 5A and 5B, respectively, may be disposed between adjacent (e.g., hexagonal) plates. For example, a supplemental plate may be coupled to a first plate and a second plate, coupling the first and second (e.g., hexagonal) plates. According to some examples, the flow chart 1300 of FIG. 13 may further include inserting a fastener through the through-holes of an adjacent pair of connectors including in adjacent support modules, connecting the adjacent connectors, and thus, the adjacent support modules including the connectors. According to some examples, one or more plates and/or supplemental plates may be coupled to one another before inserting a fastener into the through holes of adjacent connectors, coupling the adjacent connectors.

According to some examples, the flow chart 1300 of FIG. 13 may further include coupling a solar cell, for example, solar cell 1130 illustrated and described above with respect to FIG. 11, to a polygonal panel of the plurality of polygonal panels of one or more (e.g., each of) the support modules included in a solar support structure. In some examples, two solar cells may be coupled to one or more polygonal panels of the plurality of polygonal panels of one or more support modules included in the support structure. In some examples, one or more solar cells may be coupled to each polygonal panel of the plurality of polygonal panels of one or more (e.g., each of) the one or more support modules. Each solar cell may be coupled to a respective polygonal panel using an adhesive or glue, plastic welding, one or more fasteners (e.g., bolts, screws, rivets, nails, and the like), or the like, or any combination thereof.

According to some examples, one or more acts of the flow chart 1300 of FIG. 13 may be performed while in orbit (e.g., of earth) and/or after a transporting spacecraft has launched into space.

While the present invention has been described with reference to specific examples, which are intended to be illustrative only and not be limiting of the invention, it will be apparent to those of ordinary skill in the art that changes, additions, and/or deletions may be made to the disclosed embodiments without departing from the spirit and scope of the invention.

The foregoing description is given for clarity of understanding only, and no unnecessary limitations should be understood therefrom, as modifications within the scope of the invention may be apparent to those having ordinary skill in the art.

What is claimed is:

1. A support structure for a plurality of solar cells, the support structure comprising:
a truss; and
a plate engaged with the truss, the plate including a plurality of polygonal panels, the plurality of polygonal panels being arranged such that the plate has a non-planar surface,
wherein each polygonal panel of the plurality of polygonal panels is configured to support at least one solar cell of the plurality of solar cells.

2. The support structure of claim 1, wherein the truss comprises a plurality of beams, each beam of the plurality of beams comprises an elastic material and a dampening material periodically disposed within the elastic material.

3. The support structure of claim 2, wherein the dampening material is viscoelastic.

4. The support structure of claim 2, wherein each beam of the plurality of beams includes a hollow section.

5. The support structure of claim 1, wherein:
the plate includes a front side and a back side opposite the front side;
the non-planar surface is disposed on the front side; and
the back side includes a plurality of sockets configured to engage the truss.

6. The support structure of claim 5, wherein:
the truss comprises a plurality of composite beams; and
each socket of the plurality of sockets is configured to receive a respective composite beam of the plurality of composite beams of the truss for coupling the plate to the truss.

7. The support structure of claim 6, wherein the truss further comprises a connector configured to couple two or more of the plurality of composite beams.

8. The support structure of claim 5, wherein:
the plate has a polygonal perimeter that defines a plurality of corners of the plate; and
each socket of the plurality of sockets is disposed on the back side of the plate at a respective one of the corners.

9. A modular support structure for a plurality of solar cells, the support structure comprising:
a first support module and a second support module coupled to one another, the first support module and the second support module each comprising a truss and a plate engaged with the truss, the plates of the first support module and the second support module including a plurality of polygonal panels and a coupling hook configured to engage an adjacent plate, the plurality of polygonal panels arranged such that the plate has a non-planar surface,
wherein each polygonal panel of the plurality of polygonal panels of the plates of the first support module and the second support module is configured to support at least one solar cell of the plurality of solar cells.

10. The support structure of claim 9, wherein:
the plate comprises a front side and a side wall extending backward from a front side of the plate along a periphery of the plate;
the non-planar surface is disposed on the front side; and
the coupling hook comprises a spacer extending from the side wall and a flange extending from the spacer and offset from the side wall such that a slot is formed between flange and the side wall.

11. The support structure of claim 9, wherein:
the truss of each of the first support module and the second support module comprises a plurality of composite beams;
each of the first support module and the second support module further comprises a connector configured to couple two or more of the plurality of composite beams; and
the connector of each of the first support module and the second support module is configured to engage the connector of the other of the first support module and the second support module.

12. The support structure of claim 11, wherein the connector of each of the first support module and the second support module includes a through-hole configured to receive a fastener for coupling the connectors of each of the first support module and the second support module.

13. The support structure of claim 9, wherein:
the plate includes a front side and a back side;
the non-planar surface is disposed on the front side; and
the back side includes a plurality of sockets configured to engage with the truss.

14. The support structure of claim 9, wherein the truss comprises a plurality of beams, each beam of the plurality of beams comprises an elastic material and a dampening material periodically disposed within the elastic material.

15. A method of assembling a support structure for a plurality of solar cells, the support structure comprising more than one support module, with each support module including a truss comprising a plurality of beams and a plurality of connectors, and a plate including a plurality of polygonal panels, the plurality of polygonal panels arranged such that the plate has a non-planar surface, each of the polygonal panels configured to support at least one solar cell, the method comprising:
coupling the plurality of beams and the plurality of connectors, such that the truss is formed; and
coupling a subset of the plurality of beams to a back side of the plate.

16. The method of claim 15 wherein:
each connector of the plurality of connectors includes at least two ports, each of the at least two ports configured to receive a beam of the plurality of beams; and
coupling the plurality of beams and the plurality of connectors includes inserting a beam of the plurality of beams into each port of the at least two ports of each of the plurality of connectors.

17. The method of claim 15, wherein:
the back side of the plate includes a plurality of sockets; and
coupling the subset of the plurality of beams to the back side of the plate includes inserting one of the plurality of beams into each socket of the plurality of sockets.

18. The method of claim 15, wherein the plate of each support module of the more than one support modules includes a coupling hook, further comprising:
interlocking the coupling hooks of the plates of each support module of the more than one support modules, to couple the more than one support modules.

19. The method of claim 15, wherein a connector of the plurality of connectors of each support module of the more than one support modules includes a through hole configured to receive a fastener, the method further comprising:
inserting a fastener through the through hole of the connector of the plurality of connectors of one of the support modules of the more than one support modules and the connector of the plurality of connectors of another one of the support modules of the more than one support modules, coupling the connectors of the respective support modules of the more than one support modules.

20. The method of claim 15, wherein the coupling the plurality of beams and the plurality of connectors and the coupling the subset of the plurality of beams to the back side of the plate occur in orbit.
